(19) United States
(12) Patent Application Publication
(10) Pub. No.: US 2026/0017663 A1
(43) Pub. Date: Jan. 15, 2026

(54) SYSTEMS AND METHODS FOR USE IN REVERSAL OF NETWORK INTERACTIONS

(71) Applicant: MASTERCARD INTERNATIONAL INCORPORATED, PURCHASE, NY (US)

(72) Inventors: Peter Groarke, Dublin (IE); Frédéric Yann Elie Le Garrec, New Rochelle, NY (US)

(21) Appl. No.: 19/236,601

(22) Filed: Jun. 12, 2025

Related U.S. Application Data
(60) Provisional application No. 63/670,430, filed on Jul. 12, 2024.

(51) Int. Cl. G06Q 20/42

(52) U.S. Cl. CPC G06Q 20/42

(57) ABSTRACT

Systems and methods are provided for reversing one or more network interactions. One example computer-implemented method includes receiving, from a first acquirer, an authorization message associated with a network interaction, which includes a transfer from a payor account to a payee account. In connection therewith, the authorization messaging is consistent with a first message standard, and the payee account is issued by a second acquirer. The method also includes communicating the authorization message to an issuer of the payor account and initiating a timer for the network interaction. The method then includes, in response to expiration of the initiated timer, without a response message specific to the network interaction, generating and communicating, to the first acquirer, a timeout response message for the network interaction consistent with the first standard.

### CROSS-REFERENCE TO RELATED APPLICATION

This application claims the benefit of, and priority to, U.S. Patent Application No. 63/670,430, filed on Jul. 12, 2024. The entire disclosure of the above application is incorporated herein by reference.

### BACKGROUND

This section provides background information related to the present disclosure which is not necessarily prior art.

Users are known to initiate interactions with parties in various manners. For example, a user (e.g., a consumer, etc.) may present a physical card, or other device, to a first party, to initiate payment from an account associated therewith to purchase one or more products, from the first party, whereby funds are transferred from the account to an account associated with the first party. In another example, a user may transfer funds to another user, or to a business, for reasons related or unrelated to purchases. The transfers may be based on conventional credit card four-party flows, real-time payment, or other known technologies.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in reversing one or more network interactions;

FIG. 2 is a block diagram of an example computing device that may be used in the system of FIG. 1; and

FIG. 3 is a flow diagram of an example method, which may be implemented in connection with the system of FIG. 1, for reversing one or more network interactions.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In connection with real-time transfers through network interactions, funds are moved, in real-time or near real-time, from an account of a payor to an account of a payee. The payee then gets immediate access to the funds (i.e., within seconds or minutes), which may be then moved to another account or withdrawn by the payee. More recently, when the real-time interactions are initiated through conventional real-time processing networks, or otherwise, a status is also returned through the network through which the interaction was initiated. When there is no clear status of the network interactions (e.g., due to interaction timeout, failed messages, delays, etc.), however, there is limited ability to reverse the interactions (e.g., there is no separate settlement process, etc.), or to otherwise restore the funds to the payor, or more generally, to define a deterministic state. That is, for example, where a reversal message is initiated by the payor, the messaging, via the existing reversal messaging, further extends the unknown state, etc. This is a clear technical problem of the conventional real-time interactions.

Uniquely, the systems and methods herein provide for reversal of network interactions, such as, for example, real-time network interactions (e.g., real-time or near real-time transactions, etc.), such that the interactions, which have encountered issue(s), etc., are restored/returned to a deterministic state, etc.

In particular, in connection with an account to account (A2A) real-time payments (RTP) interaction, which is initiated through a conventional four-party scheme (e.g., ISO 8583 messaging, etc.), for example, in which an issuer directs the RTP interaction based on an authorization request, a timeout condition may be reached, or some other unknown state may be reached, prior to completion of messaging associated with the RTP interaction. A processing network (which passed the authorization request to the issuer) is then able to instruct (e.g., through an acquirer, etc.) a reversal of the interaction (e.g., or status check, etc.), based on the unknown state, directly with a payee bank of the interaction (e.g., apart from or separate from scheme by which the transaction was initiated, etc.). When the reversal is executed (e.g., a refusal of the reversal, or status is provided, etc.), as the payee bank is obligated to do, the RTP initiated aspect of the A2A interaction is restored to a deterministic state (i.e., the funds are in a known state), thereby informing each participant of the state of the interaction.

In this way, the payee bank is instructed to take an action and/or provide a status, directly, in a novel manner, to establish (or reestablish) the deterministic state and eliminate the uncertainty associated with the RTP interaction in reaching an unknown state. This provides a technical, network-based solution to the technical problem associated with the unknown state of real-time interactions within the system (e.g., due to network timeout, delay, or other issue, etc.) (and, thus, unknown state of the system in general). This technical solution to the unknown state of the network interaction also avoids sending additional messages along the initiating payment network for reversal (as permitted by conventional solutions), which perpetuates the unknown state and creates added network traffic, as compared to direct messaging with the payee bank to return the deterministic state while also limiting network traffic associated with the same.

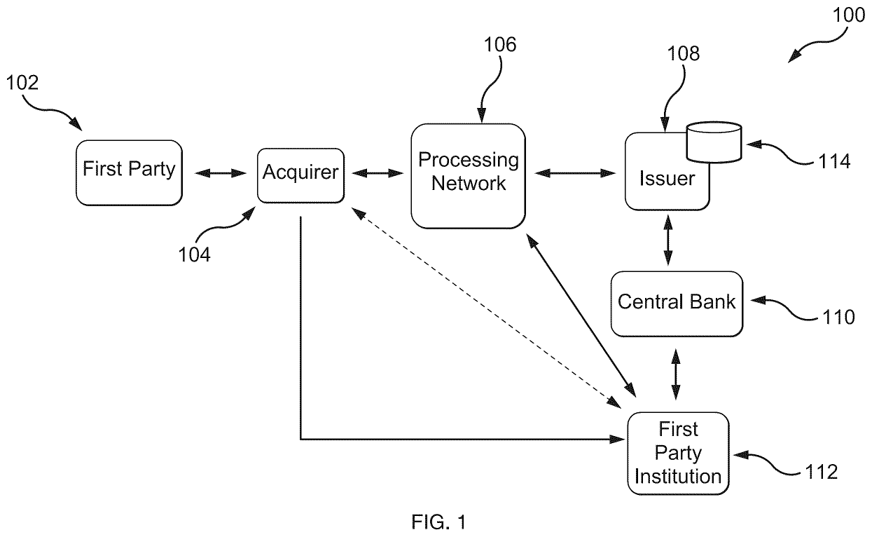

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between first parties/merchant(s) and/or processing network(s) in the system 100, types and/or features of cards or other devices employed in the system 100, etc.

As shown in FIG. 1, the illustrated system 100 generally includes a first party 102, an acquirer institution 104, a processing network 106, an issuer 108, a central bank 110, and a first party institution 112, each of which is coupled to (and is in communication with) one or more network(s) (as indicated by the arrowed lines in FIG. 1). The one or more network(s) may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, one network may include a private payment network made accessible by the processing network 106 to the issuer 108 and, separately, the public Internet, which may provide interconnection between one or more of the entities in the system 100, etc.

The first party 102 of the illustrated system 100, in general, offers products (e.g., goods, services, etc.) for sale and/or sells products to users (whereby, in this example, the first party 102 is a merchant, etc.). In connection therewith, for a purchase between a user and the first party 102, the user may be referred to as a “payor” which is the source of the funds to be paid, and the first party 102 may be referred to as a “payee” which is the recipient of the funds to be paid.

In this example embodiment, the first party 102 includes a brick-and-mortar store (e.g., a physical store location, etc.), but may also (or alternatively) include a virtual merchant location, such as, for example, a website, network-enabled application, etc. Regardless, the first party 102 permits, through the physical or virtual locations, the users, for example, to browse among the products offered for sale by the first party 102, to select one or mor products, and to purchase the one or more of the products.

The issuer 108 is, for example, a bank or other financial institution, which is configured to issue accounts to users, and further to participate in transactions (broadly, interactions) (by the users) to/from the accounts, as directed by the users. Similarly, each of the acquirer 104 and the first party institution 112 are banks or other financial institutions, which are configured to issue accounts to first parties (e.g., merchants, etc.), and further to participate in transactions to/from the accounts, as directed by the first parties, to exchange funds between different accounts. The first party 102, in this example embodiment, is associated with an account issued by the acquirer 104, and also, in this embodiment, a separate account issued by the first party institution 112.

It should be appreciated that the acquirer 104 and the first party institution 112 may be separate banks in various embodiments, as shown in FIG. 1, but also may be the same bank in various other embodiments, for example, (as indicated by the dashed line in FIG. 1).

In this example embodiment, the issuer 108 and the first party institution 112 are associated with a specialized, unconventional transaction scheme, in which the issuer 108 and the first party institution 112 are configured to issue accounts specific to the specialized transaction scheme (and corresponding specialized transactions). The accounts may be (or may be associated with), for example, geographically limited schemes, or country specific schemes, etc., such as, for example, UPI in India, PIX in Brazil, etc. It should be appreciated that the issuer 108 and the first party institution 112 may be associated with more conventional schemes as well (or instead), and/or suited to RTP interactions in other embodiments. In one or more embodiments, in which the acquirer 104 and the first party institution 112 are the same bank, for example, the first party 102 is issued two separate accounts, with one associated with the specialized scheme above. Likewise, in various embodiments, the issuer 108 may issue one account to the user, or alternatively, two accounts to the user (payor), with only one associated with or suited to fund transactions through the specialized scheme above.

With continued reference to FIG. 1, the processing network 106 is configured to coordinate messaging between the acquirer 104 and the issuer 108, in connection with a transaction between a user and the first party 102 (e.g., along the initiating payment scheme, etc.). In particular, the processing network 106 is configured to communicate through messaging consistent with one or more internationally recognized standards (e.g., ISO 8583 and ISO 20022 message standards, etc.) (e.g., conventional four-party scheme). In this particular embodiment, the processing network 106 is not configured to facilitate real-time payments (RTPs), whereby transactions associated with the processing network 106 are subject to phases including authorization, clearing and settlement over a period of time (e.g., multiple hours, day(s), etc.), or generally consistent with a conventional four-party model.

That said, in this example embodiment, the processing network 106 is configured to cooperate with the issuer 108 to integrate the ISO 8583 payment rails with the RTP payment scheme, through the issuer 108, to provide A2A real-time transactions between the issuer 108 and the first party institution 112 (or payee bank). In this way, the system 100 is configured to provide enhanced speed at a point of sale (POS) of the first party 102 (e.g., through the conventional payment initiation, etc.), access to funds in specialized accounts, enhanced user convenience (e.g., a consistent method for other transactions, etc.) and also enhanced information, as explained later, to the issuer 108 (or payor bank) and the first party institution 112 (or payee bank).

In connection therewith, in the illustrated embodiment, the issuer 108 is configured to communicate with the first party institution 112, via the central bank 110. In this example, the central bank 110 is a bank or other financial institution (e.g., a country-specific central bank, etc.), which is configured to facilitate A2A real-time transactions between accounts (e.g., payor accounts and payee accounts, etc.) (e.g., via a specialized transaction scheme, etc.), as explained in more detail below.

Based on the above, a user initiates an A2A transaction, which is designated for real-time payment (at a POS terminal of the first party 102), to fund a transaction or otherwise transfer funds from a user to the first party 102. The transaction is initiated by the user presenting a credential (e.g., a token, an account number, etc.) to the first party 102, where the credential is specific to the user's account as issued by the issuer 108 to the user. The credential may be provided from a physical card, a QR code, an electronic wallet in a mobile device of the user, or other suitable technique.

In response to the credential, the first party 102 is configured to generate an authorization message, which includes the amount to be transferred, terminal identifier, merchant identifier, acquirer identifier for the acquirer 104, the credential (e.g., for the account issued by the issuer 108 and/or a specialized account, etc.), currency, time/date, etc. Uniquely, the authorization request further includes an instruction for real-time payment and information for the specialized account of the first party 102 issued by the first party institution 112. The first party 102 is configured to communicate the authorization request to the acquirer 104, which is configured, in turn, to communication the authorization message to the issuer 108, via the processing network 106 (e.g., along the payment rails of the processing network 106, etc.).

The messages may be consistent with one or more international message standards, as noted above, for conventional four-party schemes (or similar schemes). In particular, in this example, the authorization message is an 0100 message consistent with the ISO 8583 message standard.

Upon receipt, uniquely, the issuer 108 is configured to identify the authorization message as an instruction for the real-time transaction and to extract the account information from the authorization message. In particular, based on, for example, the account information for the payee account being included which is unique, the issuer 108 is configured to identify the transaction as a real-time push payment from the payor account of the user (payor) to the payee account of the first party 102 (payee). In this example embodiment, the authorization message includes a value in a specific data element, which indicates the type of transaction. For example, the data element may include one value for a regular 0100 request for approval, and a different value for a real-time push payment (e.g., Financial Network Code DE63.1=“PIX,” presence of TxId in a dedicated field DE1005.50, etc.). In connection therewith, the issuer 108 is configured to verify the payee account in a database 114, which may be included with the issuer 108 (as shown) or associated with a third party (not shown). When associated with the third party, the issuer 108 may be configured, for example, to submit an API call to the database 114, to verify the account of the payee. In one specific example, the account of the payee is a PIX account in Brazil, whereby the account may be verified with a PIX database, but may be otherwise in other countries, or examples, etc.

Once the account is identified, the issuer 108 is configured to retrieve account details for the account of the user, including, for example, the account number, name of the user, address of the user, and other parameters or data, which may be included in the message described below, etc.

Once the account is verified and the account data is retrieved, the issuer 108 is further configured to initiate the real-time transaction (e.g., push payment, etc.) through the central bank 110, through an API call to the central bank 110 (again, for example, based on the real-time payment instruction and the identification of the payee account (which may further be used to identify the central bank 110, etc.), etc.). The API call is a PACS.008 credit transfer message in this example consistent with the ISO 20022 message standard, which instructs the transfer of funds from the account issued by the issuer 108 to the user to the account issued by the first party institution 112 to the first party 102. The PACS.008 message is compiled by the issuer 108 to include, without limitation, a message ID, creation date, settlement information, payment type, payment ID, service level, transaction ID, amount, acceptance date, payor and payee identifying information, account data, agent information, proxy, purposes, remittance information, etc. The issuer 108 is configured to then also charge or debit the account of the user for the amount of the transaction.

The central bank 110, in turn, is configured to identify the first party institution 112 from the account information and to communicate the credit transfer message to the first party institution 112. Upon receipt, the first party institution 112 is configured to credit the account of the first party 102 and to confirm transfer, through an API call to the central bank 110. The API call is a PACS.002 status report message consistent with the ISO 20022 message standard, which indicates the completed transfer of funds from the account to the user to the account issued to the first party 102. The central bank 110, in turn, is configured to communicate the status report message back to the issuer 108. The real-time transfer is complete, whereby the first party 102 is immediately able to access the funds.

In this way, the issuer 108, the central bank 110, and the first party institution 112 form a real-time payment system (e.g., which may be useable as the specialized transaction scheme, etc.), which communicates via, in this example, the ISO 20022 message standard. The real-time payment system is layered onto the conventional transaction rails with the authorization message being leveraged to initiate the real-time interaction.

The issuer 108 is configured to generate and communicate an authorization response (e.g., 0110 response message consistent with the ISO 8586 message standard, etc.), to the acquirer 104, via the processing network 106. The response message indicates the real-time transaction as being completed (e.g., a flag is set in a data element (DE) thereof, etc.) and potentially, an indication that the authorization of the initiated transaction through the conventional payment rails will not also be completed. The acquirer 104 is configured to return the response message to the first party 102, who, then, is permitted to deliver the product(s) to the user or otherwise conclude the exchange with the user.

From time to time, the messaging above may not be complete prior to a message timeout for the transaction (e.g., at the acquirer 104, the processing network 106, etc.), whereby the real-time transaction reaches an undefined state, which may need to be reversed.

In this example embodiment, in connection with the authorization message being communicated to the issuer 108, the processing network 106 is configured to initiate a timer having a defined interval sufficient to complete the real-time transaction consistent with the above (e.g., seconds, or up to a minute, etc.), and potentially, the acquirer 104 may also initiate a timer having a second defined interval (e.g., which may be the same, shorter or longer than the above interval, etc.).

In response to the timer expiring, without a response message from the issuer 108 (e.g., without receiving the authorization response from the issuer 108, etc.), for example, the processing network 106 is configured to provide a response message to the acquirer 104, which indicates a timeout decline of the transaction. The acquirer 104 may be configured to rely on the timeout decline response from the processing network 106, or rely on its own timer to determine a timeout decline. In this example embodiment, the acquirer 104, in turn, is configured to generate and submit a return payment message, through an API call to the first party institution 112. The API call is a PACS.004 return payment message consistent with the ISO 20022 message standard, which instructs the refund of the funds transferred from the account issued by the issuer 108 to the user to the account issued by the first party institution 112 to the first party 102.

The first party institution 112 is configured to determine whether the transfer was approved/declined (whereby funds were transferred). The first party institution 112 is further configured, when the transfer was declined, to take no further action. And the first party institution 112 is further configured, when the transfer was approved, to refund the transaction funds, by communicating the message back to the central bank 110, which, in turn, is configured to communicate the message to the issuer 108. Upon receipt, in this embodiment, the issuer 108 is configured to credit the account of the central bank 110 and to confirm transfer, through an API call to the central bank 110. The API call is a PACS.002 status report message in this example consistent with the ISO 20022 message standard, which indicates the completed transfer of funds from the account issued to the first party 102 (i.e., original payee account) back to the account to the user (i.e., original payor account). The central bank 110, in turn, is configured to communicate the status report message back to the first party institution 112.

In this way, the funds are indeed refunded from the account of the first party 102 at the first party institution 112 to the account of the user, thereby defining a determined state.

It should be appreciated that while the reversal instruction to the first party institution 112 is initiated by the processing network 106 in the above, the acquirer 104 may be configured to initiate the reversal, based on expiration of a timer specific to the acquirer 104 (in a manner similar to the processing network 106). In such an embodiment, the acquirer 104 is configured to directly initiate the reversal with the first party institution 112, for example, via an API call or otherwise, consistent with the description above.

Further, in other embodiments, the acquirer 104 may be configured to initiate the reversal directly on behalf of the first party institution 112, through use of an API call (and/or corresponding key) specific to the first party 102 (as indicated in FIG. 1). Further still, in other embodiments, the first party 102 may be configured to initiate the reversal with the first party institution 112, whereby the “merchant” (e.g., the first party 102, etc.) is directing its account to reverse the transaction, again, through the messaging described above.

In yet another example embodiment, in response to the above timeout decline at the processing network 106, the processing network 106 may be configured to call a status request API, which is exposed by the first party institution 112, as indicated by the line in FIG. 1 therebetween. The API call may include the specifics of the transaction sufficient for the first party institution 112 to identify the transaction. In response, the first party institution 112 is configured to determine whether the transfer was approved/declined (whereby funds were transferred). Based on the status returned, the processing network 106 is configured to report the defined state to the acquirer 104, which in turn is configured to report the status to the first party 102.

In this way, whether approved or declined, the fund transfer, i.e., push transaction via the central bank 110, which is subject to timeout, is returned to a determined state.

What's more, the timer interval of the processing network 106 is expired, which defines the decline timeout to the processing network 106, but through this embodiment, the processing network 106 is configured to retrieve a status, through the API call, from the first party institution 112 and to respond the same to the acquirer 104 prior to the separate timer interval of the acquirer 104 being expired. As such, further network traffic related to reversal or status request from the acquirer 104 is avoided.

While only the first party 102, the acquirers 104, 112, the issuer 108, and the central bank 110 are illustrated in FIG. 1, it should be appreciated that any number of these parts and/or entities (and their associated components) may be included in the system 100, or may be included as a part of systems in other embodiments, consistent with the present disclosure. Likewise, it should be appreciated that the system 100 and/or other system embodiments will generally include multiple users, each associated with an account for use in RTP interactions with the first parties, etc.

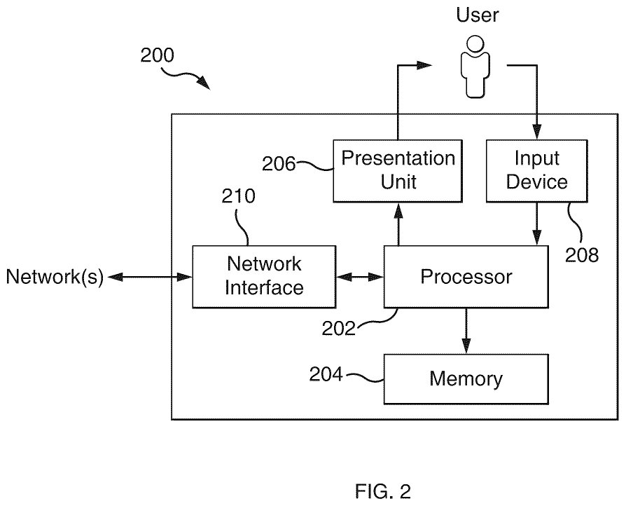

FIG. 2 illustrates an example computing device 200 that may be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to operate as described herein. In the example embodiment of FIG. 1, each of the first party 102, the acquirer 104, the processing network 106, the issuer 108, the central bank 110, and the acquirer 112 are understood to be included in, or as being generally implemented in, at least one computing device generally consistent with computing device 200, coupled to (and in communication with) the one or more networks. However, with that said, the system 100 should not be considered to be limited to the computing device 200, as described below, as different computing devices and/or arrangements of computing devices may be used.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), flash drives, CD-ROMs, thumb drives, floppy disks, tapes, hard disks, and/or any other type of volatile or nonvolatile physical or tangible computer-readable media. The memory 204 may be configured to store, without limitation, message data, instructions, transaction status, flags, and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 and/or other computer system components configured to perform one or more of the various operations herein, whereby such performance improves operation of the computing device (as described herein) and transforms the computing device 200 into a special-purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, such as indicators of successful transfers, audibly or visually, for example, to a user of the computing device 200, such as the user in the system 100 (e.g., at a mobile device of the user, at a POS terminal of the first party 102, etc.), etc. The presentation unit 206 may include, without limitation a liquid crystal display (LCD), a light-emitting diode (LED) or LED display, an organic LED (OLED) display, an “electronic ink” display, speakers, etc. In some embodiments, presentation unit 206 may include multiple devices.

In addition, the computing device 200 includes an input device 208 that receives inputs from the user of the computing device 200 (i.e., user inputs) such as, for example, credentials, etc., as further described herein. The input device 208 may include a single input device or multiple input devices. The input device 208 is coupled to (and is in communication with) the processor 202 and may include, for example, a keyboard, a pointing device, a mouse, position sensors, biometric capturing device (e.g., fingerprint sensors, camera, palm reader, etc.) or any other type of sensor, a touch sensitive panel (e.g., a touch pad or a touch screen, etc.), another computing device, and/or an audio input device, etc. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., Wi-Fi adapter, a near field communication (NFC) adapter, a Bluetooth adapter, etc.), a mobile network adapter, or other device capable of communicating to one or more different networks, including the one or more networks described above. Further, in some example embodiments, the computing device 200 may include the processor 202 and one or more network interfaces incorporated into or with the processor 202.

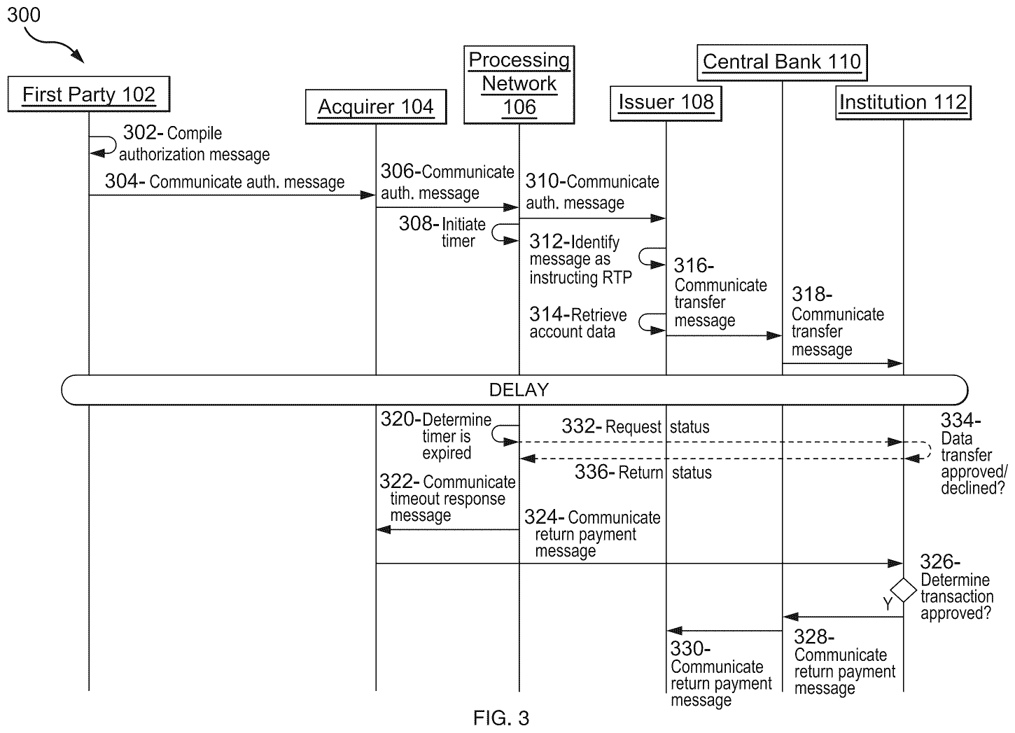

FIG. 3 illustrates an example method 300 for use in reversing one or more network interactions. The example method 300 is generally described in connection with the system 100, and in conjunction with the other entities in FIG. 1. Reference is also made to the computing device 200 of FIG. 2. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, a user instructs the first party 102 to transfer funds from the user's account issued by the issuer 108 as a real-time transfer, to the account of the first party 102 issued by the first party institution 112. In doing so, the user presents credentials indicative of the account to the first party 102.

At 302, the first party 102 compiles an authorization message (e.g., an authorization request, etc.) for a transaction between the user and the first party 102. The authorization message includes, without limitation, various data representative of the transaction. The data includes, for example, a transaction amount (i.e., an amount of funds to be transferred), time/date, merchant identifier, identifier of the acquirer 104, the credential(s) from the user (e.g., an account number for the account issued to the user by the issuer 108, etc.), and also, uniquely, account credentials for the account issued to the first party 102 by the first party institution 112. The account credentials for the account issued to the first party 102 by the first party institution 112 may include, for example, an account number or suitable proxy for the account number (e.g., email address, phone number, etc.). At 304, the first party 102 communicates the authorization message (e.g., a 0100 message consistent with the ISO 8583 standard, etc.) to the acquirer 104.

The acquirer 104 communicates, at 306, the authorization message to the processing network 106. It should be appreciated that in one or more embodiments, the acquirer 104 may compile the authorization message based on data from the first party 102 (rather than receiving the completed authorization request).

At 308, the processing network 106 initiates the timer, which includes an interval within which the transaction should be completed. The timer may include a number of seconds (e.g., five seconds, etc.), a number of minutes, or more or less, etc., as suited to the particular transaction, etc. The interval may be, for example, between about ten seconds and about ninety seconds, and more particularly, between about twenty seconds and about sixty seconds, or even more particularly, between about thirty-five seconds and about fifty seconds, etc. In general, the timer for the acquirer 104 may be longer than a timer for the processing network 106 (e.g., about forty seconds at the processing network 106, and about forty-five seconds at the acquirer 104, etc.).

Optionally (not shown), the acquirer 106 may also initiate a timer, upon communicating the authorization message to the processing network 106. The interval of the timer may be longer, in some examples, than the interval of the timer initiated by the processing network 106 (e.g., to ensure that the processing network timer expires first, if the processing network timer expires, etc.), at 308, or the same or shorter.

As further shown in FIG. 3, the processing network 106 identifies the issuer 108 (e.g., based on the credential for the account issued to the user, etc.) and communicates the authorization message to the issuer 108. It should be appreciated that while the timer is initiated at step 308 and the authorization message is communicated at step 310, the steps may be completed in the reverse order in various embodiments.

Upon receipt of the authorization message, the issuer 108 identifies, at 312, the authorization message as being indicative of a real-time transaction (e.g., a real-time push payment from the payor account to the payee account, etc.). In this particular embodiment, the issuer 108 identifies the authorization message as such, based on content of one or more data elements of the message (e.g., inclusion of account information for the payee account, etc.). In addition to identifying the message as indicative of the real-time transaction, the issuer 108, at 314, retrieves account data specific to the account issued by the issuer 108 to the user (e.g., from the database 114, or through an API call to a third party, etc.), which is sufficient to compile a transfer message (e.g., account number, name, address, etc.). In response to identifying the authorization message as indicative of a real-time transaction, and the retrieved information, the issuer 108 further compiles and communicates, at 316, a transfer message to the central bank 110. In this example embodiment, the transfer message is communicated via an API call to the central bank 110. What's more, the transfer message includes an ISO 20022 message, and in particular, a PACS.008 credit transfer message, which instructs the transfer of the transaction amount for the transaction from the account of the issuer 108 to the account of the first party 102 issued by the first party institution 112.

At 318, the central bank 110 communicates the transfer message to the first party institution 112.

In general, the real-time transaction proceeds as described above, but in the example illustrated in FIG. 3, the processing of the transaction for one reason or another experiences a delay (e.g., technical issues, delayed response, etc.), and subsequently, the processing network 106 determines, at 320, that the timer (initiated at step 308) is expired, without a response message received from the issuer 108. It should be appreciated that the delay may occur otherwise in the method 300, after the processing network 106 communicates the authorization message, but prior to receiving the response message, in other examples.

Regardless of when the delay occurs, based on the determination that the timer is expired, the processing network 106 communicates, at 322, a timeout response message (i.e., timeout decline) to the acquirer 104, indicating the delay in processing of the transaction. The timeout response message is consistent with the ISO 8583 message standard and includes sufficient data to identify the transaction.

In response, at 324, the acquirer 104 communicates a return payment message to the first party institution 112. In this example embodiment, the transfer message is communicated via an API call to the first party institution 112 (and/or to the central bank 110). What's more, the transfer message includes an ISO 20022 message, and in particular, a PACS.004 return payment message, which instructs the refund of funds transferred from the account issued by the issuer 108 to the user to the account issued by the first party institution 112 to the first party 102. It should be appreciated that the acquirer 104 may await expiration of a timer initiated by the acquirer 104, prior to communicating the return payment message, or as above, rely on the expiration determined by the processing network 106.

The first party institution 112 receives the instructions and determines, at 326, whether the transaction was approved or declined. Based on the transaction being approved, the first party institution 102 proceeds as instructed to refund any funds transferred for the transaction, by communicating, at 328, the return payment message to the central bank 110 (to effectively reverse the transaction). Based on the transaction being declined, the first party institution 112 takes no action with regard to refunding the transaction, as no funds were transferred.

When the payment message is received, the central bank 110, in turn, communicates, at 330, the return payment message to the issuer 108, whereby the refund or reversal of the real-time transaction is complete. It should be appreciated that one or more of the first party institution 112, the issuer 108, and the acquirer 104 may initiate additional messages to confirm and or acknowledge the reversal of the payment.

As an alternative, in FIG. 3, as indicated by the dotted lines, when the processing network 106 determines the timer is expired at 320, the processing may alternatively, or additionally, submit, at 332, a status request, via an API call, directly to the first party institution 112. The request may include a specific identifier for the transaction (e.g., for PIX transaction, an end-to-end identifier (EndToEndId), etc.). In response, first party institution 112 determines, at 334, whether the transaction has been approved or declined, and returns, at 336, the status directly to the processing network 106. The processing network 106 is then permitted to provide a status back to the acquirer 104. When the processing network 106 is able to provide the status prior to a timer expiration at the acquirer 104, for example, the transaction reaches a deterministic state based thereon (and the timer is halted if approved, for example). The acquirer 104 may return the status to the first party 102. If the timer at the acquirer 104 expires without the status, the acquirer 104 may then proceed as described above in order to reverse the transfer through the first party institution 112 and/or the central bank 110.

In view of the above, the systems and methods herein provide for reversal of real-time transactions, or status report, based on, for example, timeout pending messaging associated with the transaction.

In this way, the payee bank is instructed to reverse the transaction to the payor bank (which may be executed or not based on whether the original transfer was made or not), whereby the overall network is returned to a deterministic or known state (i.e., funds are return to the original state, if required). This is accomplished by messaging (e.g., PACS messaging, etc.) directly with the payee bank (via an API call, etc.), rather than sending a reversal advice message, i.e., a conventional, existing message along the initiating payment rails which serves to avoid the deterministic state, and further to account for the payor bank being unable to reverse the transaction (because there is no associated settlement). Alternatively, or additionally, the deterministic state is reached through direct communication between the processing network 106 and the first party institution 112, which avoids further messaging related to the reversal.

Consequently, the payors and payees involved in transactions initiated in the manner described herein are afforded enhanced flexibility and confidence in the proper operation of the overall system for real-time transactions, by, at least, affording a deterministic state of a transaction (e.g., through reversal, or not, etc.) after reaching a time out state. What's more, a reduction in network traffic along the network is realized, by way of the alternative messaging (directly to the payee bank) and avoidance of unnecessary instructions (e.g., reversal through conventional or other network messaging, etc.).

In one example embodiment, a computer-implemented method for reversing one or more network interactions, the method includes: receiving, at a computing device of a second acquirer, from a first acquirer, a reversal instruction message for a real-time payment (RTP) interaction to an account issued by the second acquirer, the RTP interaction initiated through the first acquirer; determining, by the computing device, whether the RTP interaction was approved or declined; and in response to determining that the RTP interaction was approved, instructing a central bank to reverse the RTP interaction, whereby funds are transferred from the second acquirer to an issuer different than the first acquirer or the second acquirer, via the central bank.

In another example embodiment, a computer-implemented method for reversing one or more network interactions, the method includes: receiving, at a computing device, from a first acquirer, an authorization message associated with a network interaction, which includes a transfer from a payor account to a payee account, the authorization messaging being consistent with a first message standard, the payee account issued by a second acquirer; communicating, by the computing device, the authorization message to an issuer of the payor account; initiating, by the computing device, a timer for the network interaction; in response to expiration of the initiated timer, without a response message specific to the network interaction, generating and communicating, by the computing device, to the second acquirer, a status request for the transaction; receiving, from the second acquirer, a response indicating a status; and providing the status to the first acquirer.

It should be appreciated that the above method embodiments may also be embodied as a system or a non-transitory computer-readable storage medium comprising executable instructions.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, at a computing device, from a first acquirer, an authorization message associated with a network interaction, which includes a transfer from a payor account to a payee account, the authorization messaging being consistent with a first message standard, the authorization message including account information specific to the payee account, the payee account issued by a second acquirer; (b) communicating, by the computing device, the authorization message to an issuer of the payor account, whereby a separate real-time transaction is initiated based on the authorization request including the account information for the payee account; (c) initiating, by the computing device, a timer for the network interactions; and/or (d) in response to expiration of the initiated timer, without a response message, from the issuer, specific to the network interaction, generating and communicating, by the computing device, to the first acquirer, a timeout response message for the network interaction consistent with the first standard, whereby the first acquirer communicates a return payment message consistent with a second message standard, to the second acquirer, whereby the second acquirer returns the payment for the separate real-time transaction from the payee account to the payor account.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art, that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for reversing one or more network interactions, the method comprising:
receiving, at a computing device, from a first acquirer, an authorization message associated with a network interaction, which includes a transfer from a payor account to a payee account, the authorization messaging being consistent with a first message standard, the authorization message including account information specific to the payee account, the payee account issued by a second acquirer;
communicating, by the computing device, the authorization message to an issuer of the payor account, whereby a separate real-time transaction is initiated based on the authorization request including the account information for the payee account;
initiating, by the computing device, a timer for the network interaction; and
in response to expiration of the initiated timer, without a response message, from the issuer, specific to the network interaction, generating and communicating, by the computing device, to the first acquirer, a timeout response message for the network interaction consistent with the first standard, whereby the first acquirer communicates a return payment message consistent with a second message standard, to the second acquirer, and whereby the second acquirer returns the payment for the separate real-time transaction from the payee account to the payor account.

2. The computer-implement method of claim 1, wherein the first standard is an Organization of International Standard, ISO 8583 standard; and
wherein the second standard is an Organization of International Standard, ISO 20022 standard.

3. The computer-implement method of claim 1, wherein the authorization request further includes account information specific to the payor account.

4. The computer-implement method of claim 1, further comprising:
receiving, by the first acquirer, the timeout response message from the computing device; and
compiling and communicating, by the first acquirer, to the second acquirer, the return payment message consistent with the second message standard, whereby the second acquirer returns the payment from the payee account to the payor account.

5. The computer-implement method of claim 4, wherein the timeout response message is a timeout decline message for the network interaction.

6. The computer-implement method of claim 4, wherein the first standard is an Organization of International Standard, ISO 8583 standard; and
wherein the second standard is an Organization of International Standard, ISO 20022 standard.

7. The computer-implement method of claim 1, wherein the authorization message includes the account information for the payee account as an instruction for the real-time transaction as a push payment from the payor account to the payee account.

8. A non-transitory computer-readable storage medium comprising executable instructions for reversing one or more network interactions, which when executed by at least one processor, cause the at least one processor to:
receive, from a first acquirer, an authorization message associated with a network interaction, which includes a transfer from a payor account to a payee account, the authorization messaging being consistent with a first message standard, the authorization message including account information specific to the payee account, the payee account issued by a second acquirer;
communicate the authorization message to an issuer of the payor account, whereby a separate real-time transaction is initiated based on the authorization request including the account information for the payee account;
initiate a timer for the network interaction; and
in response to expiration of the initiated timer, without a response message, form the issuer, specific to the network interaction, generate and communicate, to the first acquirer, a timeout response message for the network interaction consistent with the first standard, whereby the first acquirer communicates a return payment message consistent with a second message standard, to the second acquirer, and whereby the second acquirer returns the payment for the separate real-time transaction from the payee account to the payor account.

9. The non-transitory computer-readable storage medium of claim 8, wherein the first standard is an Organization of International Standard, ISO 8583 standard; and
wherein the second standard is an Organization of International Standard, ISO 20022 standard.

10. The non-transitory computer-readable storage medium of claim 8, wherein the authorization request further includes account information specific to the payor account.

11. The non-transitory computer-readable storage medium of claim 8, wherein the authorization message includes the account information of the payee account as an instruction for the real-time transaction as a push payment from the payor account to the payee account.

12. A system for reversing one or more network interactions, the system comprising:
a computing device have a processor and a memory including executable instruction, which configured the processor to:
receive, from a first acquirer, an authorization message associated with a network interaction, which includes a transfer from a payor account to a payee account, the authorization messaging being consistent with a first message standard, the authorization message including account information specific to the payee account, the payee account issued by a second acquirer;
communicate the authorization message to an issuer of the payor account, whereby a separate real-time transaction is initiated based on the authorization request including the account information for the payee account;
initiate a timer for the network interaction; and
in response to expiration of the initiated timer, without a response message, form the issuer, specific to the network interaction, generate and communicate, to the first acquirer, a timeout response message for the network interaction consistent with the first standard, whereby the first acquirer communicates a return payment message consistent with a second message standard, to the second acquirer, and whereby the second acquirer returns the payment for the separate real-time transaction from the payee account to the payor account.

13. The system of claim 12, wherein the first standard is an Organization of International Standard, ISO 8583 standard; and
wherein the second standard is an Organization of International Standard, ISO 20022 standard.

14. The system of claim 12, wherein the authorization request further includes account information specific to the payor account.

15. The system of claim 12, further comprising a first acquirer computing device of the first acquirer, the first acquirer computing device including a first processor and first memory, including first executable instructions, which configure the first processor to:
receive the timeout response message from the computing device; and
compile and communicate, to the second acquirer, the return payment message consistent with the second message standard, whereby the second acquirer returns the payment from the payee account to the payor account.

16. The system of claim 15, wherein the timeout response message is a timeout decline message for the network interaction.

17. The system of claim 16, wherein the first standard is an Organization of International Standard, ISO 8583 standard; and
wherein the second standard is an Organization of International Standard, ISO 20022 standard.
